(19) United States
(12) Patent Application Publication
(10) Pub. No.: US 2025/0150220 A1
(43) Pub. Date: May 8, 2025

(54) DISCONTINUOUS RECEPTION TIMER HANDLING WITH SEMI-PERSISTENT SCHEDULING HYBRID AUTOMATIC REPEAT REQUEST FEEDBACK

(71) Applicant: Telefonaktiebolaget LM Ericsson (publ), Stockholm (SE)

(72) Inventors: Zhenhua ZOU, Sollentuna (SE); Alexey SHAPIN, Linköping (SE)

(21) Appl. No.: 18/835,561

(22) PCT Filed: Feb. 8, 2023
(86) PCT No.: PCT/EP2023/053139

§ 371 Date: Aug. 2, 2024

Related U.S. Application Data
(60) Provisional application No. 63/308,249, filed on Feb. 9, 2022.

(51) Int. Cl. H04L 1/1867; H04W 72/0446; H04W 72/23

(52) U.S. Cl. CPC H04L 1/1896; H04W 72/0446; H04W 72/23

(57) ABSTRACT

A communication device of a communications network can receive a downlink (“DL”) hybrid automatic repeat request (“HARQ”) message for DL semi-persistent scheduling (“SPS”) from a network node in the communications network. The communication device can determine that HARQ feedback has not been transmitted to the network node in response to the DL HARQ message within a period of time. The communication device can, responsive to determining that the HARQ feedback has not be transmitted to the network node within the period of time, initiate a timer associated with monitoring for retransmission of the DL HARQ message.

### INTRODUCTION

The present disclosure is related to wireless communication systems and more particularly to calculating communication device mobility state using reference frequency.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

In Rel-15/16 of the 3^{rd} generation partnership project (“3GPP”), a physical uplink control channel (“PUCCH”) carrying semi-persistent scheduling (“SPS”) hybrid automatic repeat request (“HARQ”) feedback is dropped if it collides with a downlink (“DL”) symbol on a time division duplex (“TDD”) carrier. This deficiency has been addressed in Rel-17, such that the SPS HARQ feedback can be deferred to a later slot. As a result, dropping of SPS HARQ-acknowledgment (“ACK”) on a TDD carrier can be avoided. The UE checks the validity of a target slot/sub-slot for deferral, one slot/sub-slot by one slot/sub-slot and in a sequential order. Due to that there is a maximum allowed SPS HARQ-ACK deferral value, the SPS HARQ-ACK can still be dropped. For example, if the maximum SPS HARQ-ACK deferral value is radio resource control (“RRC”) configured to be one slot and both the current and the next slot are for DL transmission in TDD carrier, then the SPS HARQ-ACK is dropped.

Discontinuous Reception (“DRX”) governs the PDCCH monitoring activity of the UE in a RRC connected mode. FIG. 2 illustrates an example of a DRX cycle. When DRX is configured, the UE does not have to continuously monitor PDCCH. DRX is characterized by on-duration, an inactivity-timer, a retransmission-timer, a cycle, and an active-time.

The on-duration refers to a duration that the UE waits, after waking up, to receive PDCCHs. If the UE successfully decodes a PDCCH, the UE stays awake and starts the inactivity timer.

The inactivity-timer refers to a duration that the UE waits to successfully decode a PDCCH, from the last successful decoding of a PDCCH, failing which it can go back to sleep. The UE shall restart the inactivity timer following a single successful decoding of a PDCCH for a first transmission only (i.e. not for retransmissions).

The retransmission-timer refers to a duration until a retransmission can be expected.

The cycle specifies the periodic repetition of the on-duration followed by a possible period of inactivity.

The active-time refers to the total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

A set of timers can be used to determine when to monitor the PDCCH. In some examples, in the context of DL SPS, drx-RetransmissionTimerDL and drx-HARQ-RTT-TimerDL are used. PDSCH of DL SPS is transmitted from the network according to a pre-defined periodic pattern (e.g., every x slots) and there is no need for PDCCH monitoring (except the initial SPS activation downlink control information (“DCI”) command). When one media access control (“MAC”) protocol data unit (“PDU”) is received according to the pre-defined pattern and exactly after transmitting the DL HARQ feedback, the UE shall start the drx-HARQ-RTT-TimerDL. While the timer is running, the UE is not required to monitor the PDCCH. As the name suggests, this is to leave time for round trip time (“RTT”) of HARQ operation, for example, for gNB to decode and prepare a retransmission assignment. In other words, the gNB would not send a retransmission assignment in this time period. After this drx-HARQ-RTT-TimerDL timer expires and if the decoding was not successful, the UE shall start drx-RetransmissionTimerDL during which the UE shall monitor PDCCH for any possible DCI command for retransmission.

### SUMMARY

There currently exist certain challenges. Even with the Rel-17 SPS physical downlink shared channel (“PDSCH”) HARQ-ACK deferral, the DL HARQ feedback may not be transmitted (i.e., dropped) due to an overlapping with DL slot/sub-slot/symbol in a TDD configuration. However, this means no DL HARQ feedback has been transmitted and so subsequently the drx-HARQ-RTT-TimerDL is not started which means that drx-RetransmissionTimerDL is not started. Eventually, the UE may not monitor PDCCH and so miss the retransmission DL assignment DCI command from the network.

Certain aspects of the disclosure and their embodiments may provide solutions to these or other challenges. Various embodiments herein provide ways to handle the DRX operation when the DL SPS HARQ ACK feedback is dropped.

In some embodiments, if the DL HARQ feedback for DL SPS is not transmitted (including that a maximum deferral is reached), then the UE starts the timers drx-HARQ-RTT-TimerDL at a specified symbol (e.g., the configured transmission opportunity by the network for DL HARQ feedback but cannot be transmitted due to various reasons).

In additional or alternative embodiments, if the DL HARQ feedback for DL SPS is not transmitted (including that a maximum deferral is reached), then the UE starts the timers drx-RetransmissionTimerDL at a specified symbol (e.g., after the PDSCH transmission, at the next available DL transmission opportunity, or the configured transmission opportunity by the network for DL HARQ feedback but cannot be transmitted due to various reasons).

In additional or alternative embodiments, the drx-RetransmissionTimerDL is started in response to an absence of actual transmission of DL HARQ feedback.

According to some embodiments, a method of operating a communication device of a communications network is provided. The method includes receiving a downlink (“DL”) hybrid automatic repeat request (“HARQ”) message for DL semi-persistent scheduling (“SPS”) from a network node in the communications network. The method further includes determining (730) that HARQ feedback has not been transmitted to the network node in response to the DL HARQ message within a period of time. The method further includes, responsive to determining that the HARQ feedback has not be transmitted to the network node within the period of time, initiating a timer associated with monitoring for retransmission of the DL HARQ message.

According to other embodiments, a method of operating a network node of a communications network is provided. The method includes transmitting a downlink (“DL”) hybrid automatic repeat request (“HARQ”) message for semi-persistent scheduling (“SPS”) to a communications device in the communications network. The method further includes determining that HARQ feedback in response to the DL HARQ message has not been received from the communication device within a period of time. The method further includes, responsive to determining that the HARQ feedback has not be received from the communication device within the period of time, determining that the communication device has initiated a timer associated with monitoring for retransmission of the DL HARQ message.

According to other embodiments, a communication device, network node, system, host, computer program, computer program product, or non-transitory computer readable medium is provided to perform one of the above methods.

Certain embodiments may provide one or more of the following technical advantages. By adding conditions in which the drx-HARQ-RTT-TimerDL and drx-RetransmissionTimerDL can be started, it is guaranteed that the UE will monitor the PDCCH. Consequently, the network can immediately transmit a DL retransmission assignment to recover the data. Compared to the existing specs in which the network can only transmit such a retransmission assignment in the next on-duration, the packet delay is reduced.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a diagram illustrating an example of a discontinuous reception (“DRX”) cycle;

FIG. 3 is a diagram illustrating an example of the use of an inactive timer and an active timer by a UE;

FIG. 4 is a diagram illustrating an example of a drx-HARQ-RTT-TimerDL start when expected hybrid automatic repeat request (“HARQ”) feedback is not transmitted in accordance with some embodiments;

FIG. 5 is a diagram illustrating an example of a drx-HARQ-RTT-TimerDL start when HARQ feedback is deferred in accordance with some embodiments;

FIG. 6 is a diagram illustrating an example of a drx-RetransmissionTimerDL start when HARQ feedback is dropped due to TDD in accordance with some embodiments;

FIG. 7 is a flow chart illustrating an example of operations performed by a communication device in accordance with some embodiments;

FIG. 8 is a flow chart illustrating an example of operations performed by a network node in accordance with some embodiments;

FIG. 9 is a block diagram of a communication system in accordance with some embodiments;

FIG. 10 is a block diagram of a user equipment in accordance with some embodiments

FIG. 11 is a block diagram of a network node in accordance with some embodiments;

FIG. 12 is a block diagram of a host computer communicating with a user equipment in accordance with some embodiments;

FIG. 13 is a block diagram of a virtualization environment in accordance with some embodiments; and

FIG. 14 is a block diagram of a host computer communicating via a base station with a user equipment over a partially wireless connection in accordance with some embodiments in accordance with some embodiments.

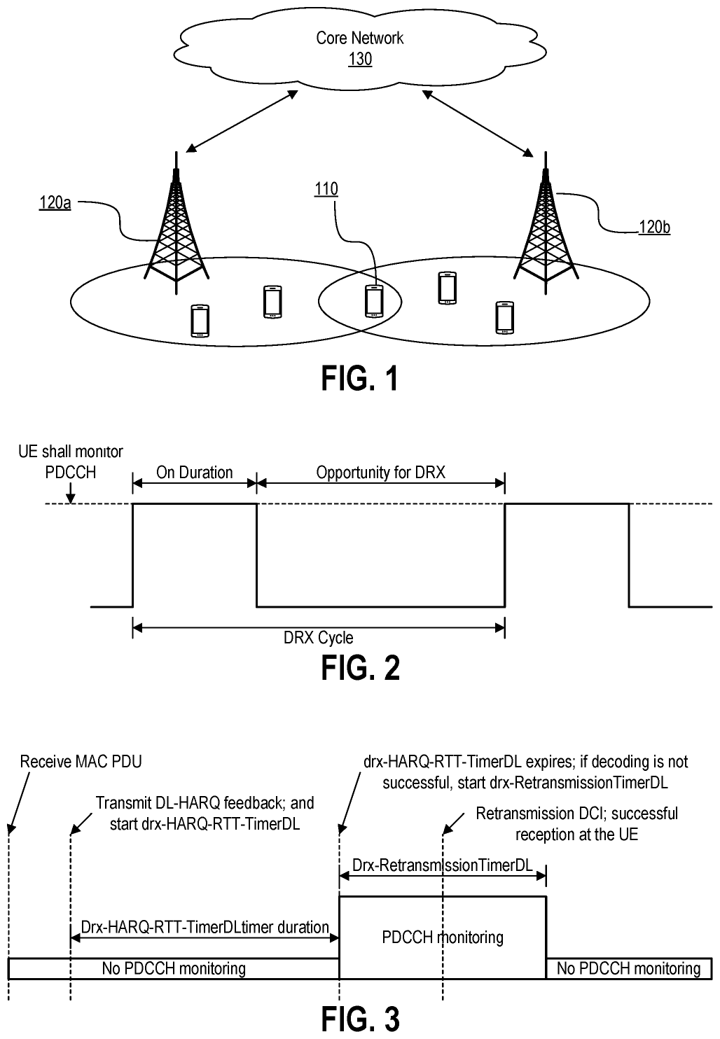

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

FIG. 3 illustrates an example of the use of a drx-HARQ-RTT-TimerDL timer and a drx-RetransmissionTimerDL in association with PDCCH monitoring.

Although the present disclosure often refers to a drx-HARQ-RTT-TimerDL timer and a drx-RetransmissionTimerDL timer and suitable timers can be used to determine an active period and inactive period of a UE in communication with a network node.

A portion of the relative features (clause 5.7) of a MAC spec (TS 38.321) are described below.

RRC controls DRX operation by configuring the following parameters: drx-onDurationTimer; drx-InactivityTimer; drx-RetransmissionTimerDL (per DL HARQ process except for the broadcast process); and drx-HARQ-RTT-TimerDL (per DL HARQ process except for the broadcast process). The drx-onDurationTimer is the duration at the beginning of a DRX Cycle. The drx-InactivityTimer is the duration after the PDCCH occasion in which a PDCCH indicates a new UL or DL transmission for the MAC entity. The drx-RetransmissionTimerDL (per DL HARQ process except for the broadcast process) is the maximum duration until a DL retransmission is received. The drx-HARQ-RTT-TimerDL (per DL HARQ process except for the broadcast process) is the minimum duration before a DL assignment for HARQ retransmission is expected by the MAC entity.

When DRX is configured, the Active Time includes the time while drx-onDurationTimer or drx-InactivityTimer or drx-RetransmissionTimerDL among other conditions.

When DRX is configured, the MAC entity shall:
1> if a MAC PDU is received in a configured downlink assignment:
   2> start the drx-HARQ-RTT-TimerDL for the corresponding HARQ process in the first symbol after the end of the corresponding transmission carrying the DL HARQ feedback;
   2> stop the drx-RetransmissionTimerDL for the corresponding HARQ process.
1> if a drx-HARQ-RTT-TimerDL expires:
   2> if the data of the corresponding HARQ process was not successfully decoded:
      3> start the drx-RetransmissionTimerDL for the corresponding HARQ process in the first symbol after the expiry of drx-HARQ-RTT-TimerDL.
1> if the MAC entity is in Active Time:
   2> monitor the PDCCH on the Serving Cells in this DRX group as specified in TS 38.213 [6];
   2> if the PDCCH indicates a DL transmission:
      3> start the drx-HARQ-RTT-TimerDL for the corresponding HARQ process in the first symbol after the end of the corresponding transmission carrying the DL HARQ the feedback;
      3> stop the drx-RetransmissionTimerDL for the corresponding HARQ process.
      3> if the PDSCH-to-HARQ feedback timing indicate a non-numerical k1 value as specified in TS 38.213:
         4> start the drx-RetransmissionTimerDL in the first symbol after the (end of the last) PDSCH transmission (within a bundle) for the corresponding HARQ process.
   2> if the PDCCH indicates a new transmission (DL or UL) on a Serving Cell in this MAC entity:
      3> start or restart drx-InactivityTimer for this DRX group in the first symbol after the end of the PDCCH reception.

When HARQ feedback is postponed by PDSCH-to-HARQ_feedback timing indicating a non-numerical k1 value, as specified in TS 38.213, the corresponding transmission opportunity to send the DL HARQ feedback is indicated in a later PDCCH requesting the HARQ-ACK feedback.

A PDCCH indicating activation of SPS or configured grant type 2 is considered to indicate a new transmission.

Various embodiments herein consider the case when the downlink (“DL”) hybrid automatic repeat request (“HARQ”) process feedback is scheduled accordingly but was dropped due to overlapping with invalid resources for physical uplink control channel (“PUCCH”) transmission. For example, when PUCCH for HARQ feedback is deprioritized in intra-user equipment (“UE”) multiplexing procedure, or when it is overlapped with semi-statically configured DL symbols on time division duplex (“TDD”) carrier, or when slot format indicator indicates that some uplink (“UL”) symbols intended for PUCCH are switched to downlink.

Initialization of a timer (e.g., drx-HARQ-RTT-TimerDL timer) associated with a period of time in which the UE is not monitoring the physical downlink control channel (“PDCCH”) is described below.

In some embodiments, after receiving a media access control (“MAC”) protocol data unit (“PDU”) in a configured downlink assignment (e.g., a DL semi-persistent scheduling (“SPS”)) which is associated with a HARQ process, if there is no corresponding transmission carrying the DL HARQ feedback, the communication device (also referred to herein as a user equipment (“UE”)) starts the timer drx-HARQ-RTT-TimerDL for the corresponding HARQ process at a specified symbol.

In some examples, the UE stops the drx-RetransmissionTimerDL timer for the corresponding HARQ process also at the same specified symbol.

In additional or alternative examples, the specific symbol can be the first symbol after the hypothetical transmission carrying the DL HARQ process feedback based on configured k1 and PUCCH resource for a given DL SPS. The term “hypothetical” here means that the DL HARQ process feedback is scheduled accordingly but was dropped due to overlapping with invalid resources for PUCCH transmission (e.g., DL symbol in TDD). Examples of the specific symbol include: the first symbol after the PUCCH indicated by sps-PUCCH-AN-List-r16; the first symbol after the PUCCH indicated by n1-PUCCH-AN in SPS-config; and in the case that SPS HARQ-ACK deferral is configured, the first symbol after the earliest valid PUCCH for HARQ-ACK transmission in accordance to provided tdd-UL-DL-ConfigurationCommon, if it is earlier than provided maximum SPS HARQ-acknowledgment (“ACK”) deferral value, otherwise, the first symbol after the transmission according to the maximum SPS HARQ-ACK deferral value.

In additional or alternative examples, the specific symbol is the exact symbol at the hypothetical transmission

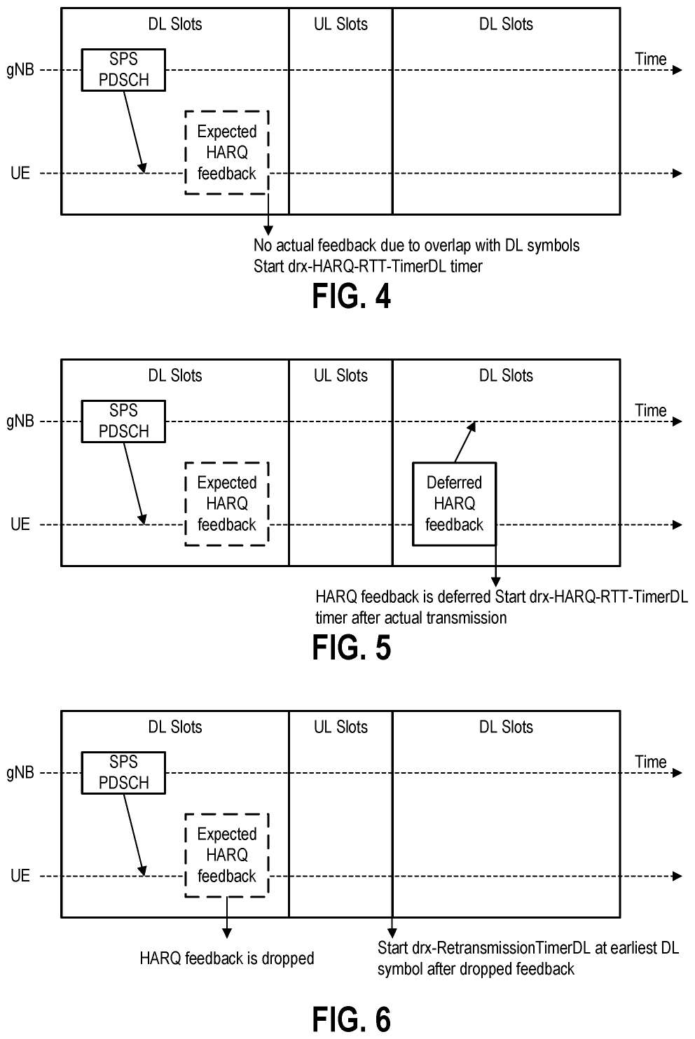

FIG. 4 illustrates an example of a drx-HARQ-RTT-TimerDL start when an expected HARQ feedback is not transmitted.

FIG. 5 illustrates an example of a drx-HARQ-RTT-TimerDL start when a HARQ feedback is deferred due to SPS HARQ feedback deferral.

Initialization of a timer (e.g., drx-RetransmissionTimerDL timer) associated with a period of time in which the UE monitors the physical downlink control channel (“PDCCH”) is described below.

In some embodiments, after receiving a MAC PDU in a configured downlink assignment (DL SPS) which is associated with a HARQ process, if there is no corresponding transmission carrying the DL HARQ feedback, the UE starts the timer drx-RetransmissionTimerDL at the first symbol for which there is a possible DL slot/subslot/symbol transmission. This is to ensure that the PDCCH monitoring would continue and the expectation for the UE would be that the gNB would for-sure schedule a retransmission since the gNB is not aware of the transmission outcome. This can be useful for a static TDD pattern.

FIG. 6 illustrates an example of a drx-RetransmissionTimerDL start when HARQ feedback is dropped due to TDD.

In the case that SPS HARQ-ACK deferral is configured, the UE may consider that there is no corresponding transmission carrying the DL HARQ feedback only if the maximum configured deferral amount has been reached.

In additional or alternative embodiments, after receiving a MAC PDU in a configured downlink assignment (DL SPS) which is associated with a HARQ process, if there is no corresponding transmission carrying the DL HARQ feedback, the UE starts the timer drx-RetransmissionTimerDL in the first symbol after the (end of the last) PDSCH transmission (within a bundle) for the corresponding HARQ process. This is also to ensure that the PDCCH monitoring would continue and the expectation for the UE would be that the gNB would for-sure schedule a retransmission since the gNB is not aware of the transmission outcome. This can be useful for a dynamic TDD pattern.

In the case that SPS HARQ-ACK deferral is configured, the UE considers that there is no corresponding transmission carrying the DL HARQ feedback only if the maximum configured deferral amount has been reached.

In additional or alternative embodiments, after receiving a MAC PDU in a configured downlink assignment (e.g., DL SPS), which is associated with a HARQ process, if there is no corresponding transmission carrying the DL HARQ feedback, the UE starts the timer drx-RetransmissionTimerDL at a specific symbol. The definition of the specific symbol can be similar to any of those described above in association with the inactivity timer (e.g., after the PDSCH transmission or at the next available DL transmission opportunity, or the configured transmission opportunity by the network for DL HARQ feedback but cannot be transmitted).

In additional or alternative embodiments, start of drx-RetransmissionTimerDL can be conditioned by absence of actual transmission of DL HARQ feedback. Since HARQ feedback is not to be transmitted at all, the gNB may want to schedule retransmission and try to get a feedback in the next attempt. In some existing procedures, the drx-retransmision TimerDL is started only if the transmission was not successful. In this embodiment, the UE can restart the timer even if the transmission was successful. An example of the specification change can be the following:
1> if a drx-HARQ-RTT-TimerDL expires:
   2> if the data of the corresponding HARQ process was not successfully decoded or there was no corresponding transmission carrying the DL HARQ feedback:
      3> start the drx-RetransmissionTimerDL for the corresponding HARQ process in the first symbol after the expiry of drx-HARQ-RTT-TimerDL.

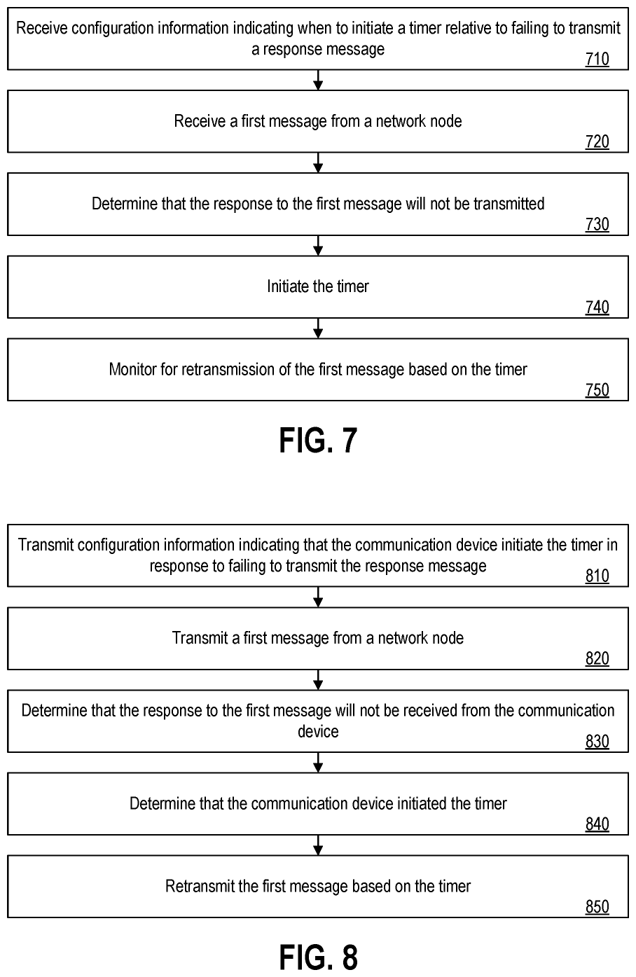

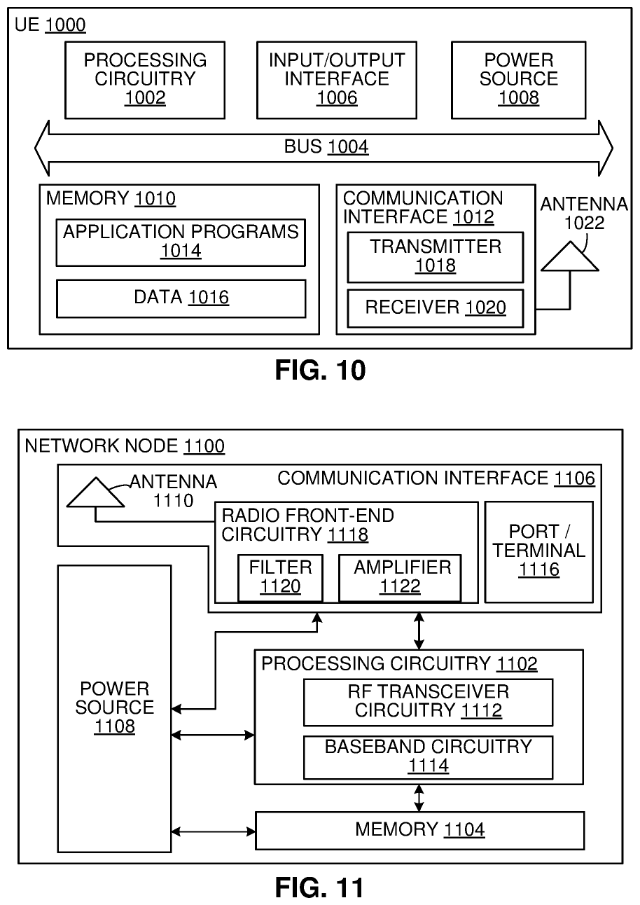

In the description that follows, while the communication device may be any of UE 912A-D, 1000, hardware 1304, or virtual machine 1308A, 1308B, the communication device 1000 shall be used to describe the functionality of the operations of the communication device. Operations of the communication device 1000 (implemented using the structure of FIG. 10) will now be discussed with reference to the flow chart of FIG. 7 according to some embodiments of inventive concepts. For example, modules may be stored in memory 1010 of FIG. 10, and these modules may provide instructions so that when the instructions of a module are executed by respective communication device processing circuitry 1002, processing circuitry 1002 performs respective operations of the flow chart.

FIG. 7 illustrates an example of operations performed by a communication device of a communications network.

At block 710 processing circuitry 1002 receives, via communication interface 1012, configuration information indicating when to initiate a timer relative to the communication device failing to transmit a response message.

At block 720, processing circuitry 1002 receives, via communication interface 1012, a first message from the network node. In some embodiments, the first message includes a MAC PDU.

At block 730, processing circuitry 1002 determines that the response to the first message will not be transmitted within a period of time. In some embodiments, the response to the first message includes HARQ feedback. In additional or alternative embodiments, determining that the response to the first message will not be transmitted to the network node within the period of time includes determining that the response is scheduled during a DL time slot. In additional or alternative embodiments, determining that the response to the first message will not be transmitted to the network node within the period of time includes determining that the response to the first message has not been transmitted within a predetermined maximum delay.

At block 740, processing circuitry 1002 initiates the timer. In some embodiments, initiating the timer includes initiating the timer at an end to the period of time or at a first occasion after the period of time ends that the communication device can receive the retransmission of the first message. In additional or alternative embodiments, initiating the timer includes initiating the timer based on the configuration information.

In some embodiments, the timer includes an inactivity timer indicating an amount of time that the communication device will wait before monitoring for retransmission of the first message. In some examples, the retransmission timer includes a drx-HARQ-RTT-TimerDL timer.

In additional or alternative embodiments, the timer includes a retransmission timer indicating an amount of time that the communication device will monitor for retransmission of the first message. In some examples, the retransmission timer includes a drx-Retransmission TimerDL timer.

At block 750, processing circuitry 1002 monitors, via communication interface 1012, for retransmission of the first message based on the timer. In some embodiments, monitoring for retransmission of the first message comprises monitoring a PDCCH for DCI from the network node.

Various operations of FIG. 7 may be optional with respect to some embodiments. For example, in regards to Embodiment 1 (described below), blocks 710 and 750 may be optional.

In the description that follows, while the network nodes may be any of the network node 910A, 910B, 1100, 1406, hardware 1304, or virtual machine 1308A, 1308B, the network node 1100 shall be used to describe the functionality of the operations of the network node. Operations of the network node 1100 (implemented using the structure of FIG. 11) will now be discussed with reference to the flow chart of FIG. 8 according to some embodiments of inventive concepts. For example, modules may be stored in memory 1104 of FIG. 11, and these modules may provide instructions so that when the instructions of a module are executed by respective network node processing circuitry 1102, processing circuitry 1102 performs respective operations of the flow chart.

FIG. 8 illustrates an example of operations performed by a network node of a communications network.

At block 810 processing circuitry 1102 transmits, via communication interface 1106, configuration information indicating that a communication device initiate a timer in response to failing to transmit a response message.

At block 820, processing circuitry 1102 transmits, via communication interface 1106, a first message to the communication device. In some embodiments, the first message includes a MAC PDU.

At block 830, processing circuitry 1102 determines that the response to the first message will not be received from the communication device. In some embodiments, the response to the first message includes HARQ feedback. In additional or alternative embodiments, determining that the response to the first message will not be received from the communication device within the period of time includes determining that the response is scheduled during a DL time slot. In additional or alternative embodiments, determining that the response to the first message will not be received from the communication device within the period of time includes determining that the response to the first message has not been received within a predetermined maximum delay.

At block 840, processing circuitry 1102 determines that the communication device initiated the timer. In some embodiments, determining that the communication device initiated the timer includes determining that the communication device initiated the timer at an end to the period of time or at a first occasion after the period of time ends that the communication device can receive the retransmission of the first message. In additional or alternative embodiments, determining that the communication device initiated the timer includes determining that the communication device initiated the timer based on the configuration information.

In some embodiments, the timer includes an inactivity timer indicating an amount of time that the communication device will wait before monitoring for retransmission of the first message. In some examples, the retransmission timer includes a drx-HARQ-RTT-TimerDL timer.

In additional or alternative embodiments, the timer includes a retransmission timer indicating an amount of time that the communication device will monitor for retransmission of the first message. In some examples, the retransmission timer includes a drx-RetransmissionTimerDL timer.

At block 850, processing circuitry 1102 retransmits, via communication interface 1106, the first message based on the timer. In some embodiments, retransmitting the first message includes transmitting DCI via a PDCCH while a retransmission timer is active in the UE.

Various operations of FIG. 8 may be optional with respect to some embodiments. For example, in regards to Embodiment 11 (described below), blocks 810 and 850 may be optional.

Example Embodiments are described below.

Embodiment 1. A method of operating a communication device of a communications network, the method comprising:
receiving (720) a first message from a network node in the communications network;
determining (730) that a response to the first message has not been transmitted to the network node within a period of time; and
responsive to determining that the response to the first message will not be transmitted to the network node within the period of time, initiating (740) a timer associated with monitoring for retransmission of the first message.

Embodiment 2. The method of Embodiment 1, wherein the first message comprises a media access control, MAC, protocol data unit, PDU,
wherein the response to the first message comprises hybrid automatic repeat request, HARQ, feedback,
wherein initiating the timer comprises initiating the timer at an end to the period of time or at a first occasion after the period of time ends that the communication device can receive the retransmission of the first message, and
wherein monitoring for retransmission of the first message comprises monitoring a physical downlink control channel, PDCCH, for downlink control information, DCI, from the network node.

Embodiment 3. The method of any of Embodiments 1-2, wherein determining that the response to the first message will not be transmitted to the network node within the period of time comprises determining that the response is scheduled during a downlink, DL, time slot.

Embodiment 4. The method of any of Embodiments 1-2,
receiving maximum delay (defer) configuration information from the network node, the maximum indicating a point at which to drop the message,
wherein determining that the response to the first message will not be transmitted to the network node within the period of time comprises determining that the response to the first message has not been transmitted within a predetermined maximum delay.

Embodiment 5. The method of any of Embodiments 1-4, wherein the timer comprises an inactivity timer indicating an amount of time that the communication device will wait before monitoring for retransmission of the first message.

Embodiment 6. The method of Embodiment 5, wherein the inactivity timer comprises a drx-HARQ-RTT-TimerDL timer.

Embodiment 7. The method of any of Embodiments 1-4, wherein the timer comprises a retransmission timer indicating an amount of time that the communication device will monitor for retransmission of the first message.

Embodiment 8. The method of Embodiment 7, wherein the retransmission timer comprises a drx-RetransmissionTimerDL timer.

Embodiment 9. The method of any of Embodiments 1-8, further comprising:
monitoring (750) for retransmission of the first message from the network node based on the timer.

Embodiment 10. The method of any of Embodiments 1-9, further comprising:
receiving (710) configuration information from the network node, the configuration information indicating that the communication device is to initiate the timer in response to failing to transmit the response message,
wherein initiating the timer comprises initiating the timer based on the configuration information.

Embodiment 11. A method of operating a network node of a communications network, the method comprising:
transmitting (820) a DL SPS first message to a communications device in the communications network;
determining (830) that a response to the first message has not been received from the communication device within a period of time; and
responsive to determining that the response to the first message will not be received from the communication device within the period of time, determining (840) that the communication device has initiated a timer associated with monitoring for retransmission of the first message.

Embodiment 12. The method of Embodiment 11, wherein the first message comprises a media access control, MAC, protocol data unit, PDU,
wherein the response to the first message comprises hybrid automatic repeat request, HARQ, feedback, and
wherein monitoring for retransmission of the first message comprises monitoring a physical downlink control channel, PDCCH, for downlink control information, DCI, from the network node.

Embodiment 13. The method of any of Embodiments 11-12, wherein determining that the response to the first message will not be received from the communication device within the period of time comprises determining that the response is scheduled during a downlink, DL, time slot.

Embodiment 14. The method of any of Embodiments 11-12, wherein determining that the response to the first message will not be received from the communication device within the period of time comprises determining that the response to the first message has not been received within a predetermined maximum delay.

Embodiment 15. The method of any of Embodiments 11-14, wherein the timer comprises an inactivity timer indicating an amount of time that the communication device will wait before monitoring for retransmission of the first message.

Embodiment 16. The method of Embodiment 15, wherein the retransmission timer comprises a drx-HARQ-RTT-TimerDL timer.

Embodiment 17. The method of any of Embodiments 11-14, wherein the timer comprises a retransmission timer indicating an amount of time that the communication device will monitor for retransmission of the first message.

Embodiment 18. The method of Embodiment 17, wherein the retransmission timer comprises a drx-RetransmissionTimerDL timer.

Embodiment 19. The method of any of Embodiments 11-18, further comprising:
retransmitting (850) the first message to the communication device based on the timer.

Embodiment 20. The method of any of Embodiments 11-19, further comprising:
transmitting (810) configuration information to the communication device, the configuration information indicating that the communication device initiate the timer in response to failing to transmit the response message.

Embodiment 21. A communication device (912A-D, 1000, 1304) operating in a communications network, the communication device comprising:
processing circuitry (1002); and
memory (1010) coupled to the processing circuitry and having instructions stored therein that are executable by the processing circuitry to cause the communication device to perform operations comprising any of the operations of Embodiments 1-10.

Embodiment 22. A computer program comprising program code to be executed by processing circuitry (1002) of a communication device (912A-D, 1000, 1304) operating in a communications network, whereby execution of the program code causes the communication device to perform operations comprising any operations of Embodiments 1-10.

Embodiment 23. A computer program product comprising a non-transitory storage medium (1010) including program code to be executed by processing circuitry (1002) of a communication device (912A-D, 1000, 1304) operating in a communications network, whereby execution of the program code causes the communication device to perform operations comprising any operations of Embodiments 1-10.

Embodiment 24. A non-transitory computer-readable medium having instructions stored therein that are executable by processing circuitry (1002) of a communication device (912A-D, 1000, 1304) operating in a communications network to cause the communication device to perform operations comprising any of the operations of Embodiments 1-10.

Embodiment 25. A network node (908, 910A, 910B, 1100, 1406, 1304, 1308A, 1308B) operating in a communications network, the network node comprising:
processing circuitry (1102); and
memory (1104) coupled to the processing circuitry and having instructions stored therein that are executable by the processing circuitry to cause the network node to perform operations comprising any of the operations of Embodiments 11-20.

Embodiment 26. A computer program comprising program code to be executed by processing circuitry (1102) of a network node (908, 910A, 910B, 1100, 1406, 1304, 1308A, 1308B) operating in a communications network, whereby execution of the program code causes the network node to perform operations comprising any operations of Embodiments 11-20.

Embodiment 27. A computer program product comprising a non-transitory storage medium (1104) including program code to be executed by processing circuitry (1102) of a network node (908, 910A, 910B, 1100, 1406, 1304, 1308A, 1308B) operating in a communications network, whereby execution of the program code causes the network node to perform operations comprising any operations of Embodiments 11-20.

Embodiment 28. A non-transitory computer-readable medium having instructions stored therein that are executable by processing circuitry (1102) of a network node (908, 910A, 910B, 1100, 1406, 1304, 1308A, 1308B) operating in a communications network to cause the network node to perform operations comprising any of the operations of Embodiments 11-20.

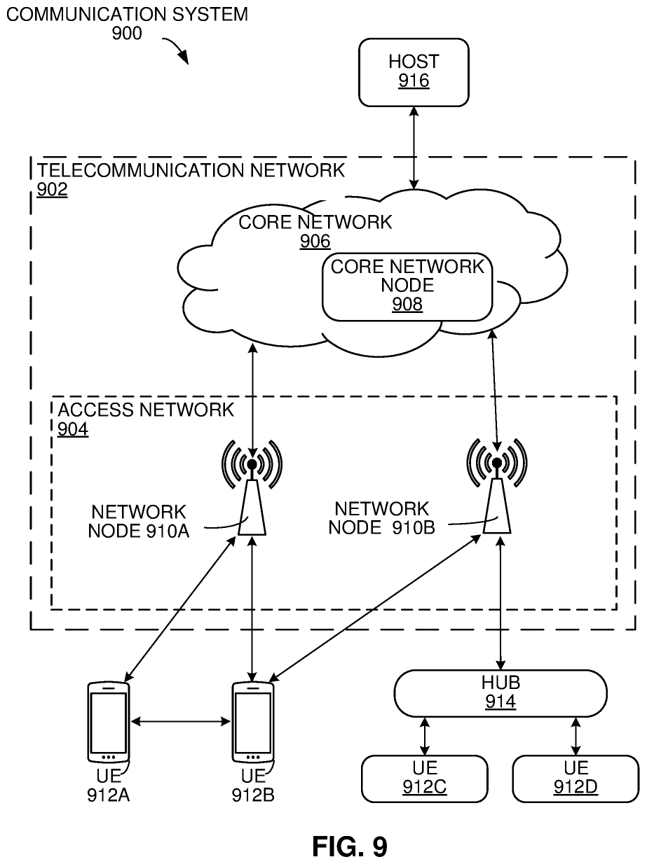

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3rd Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

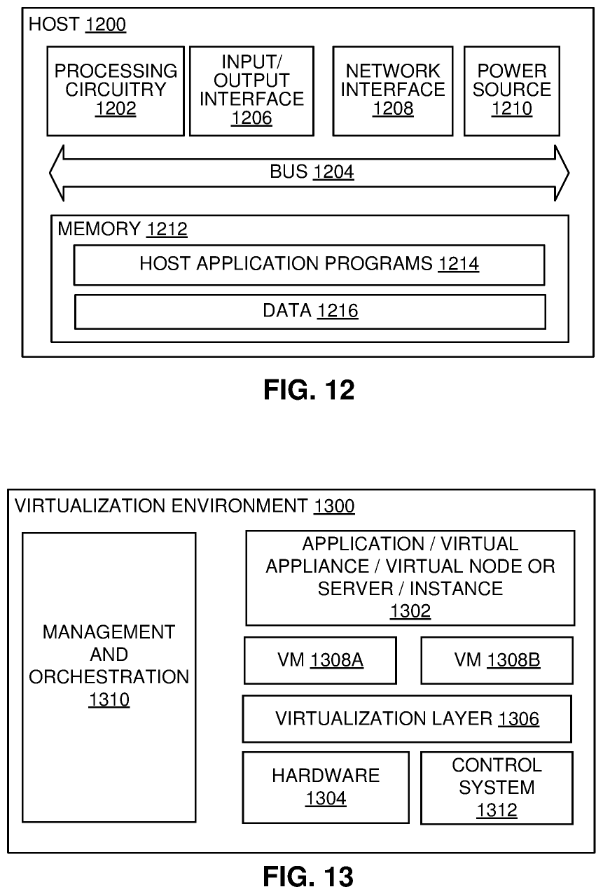

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

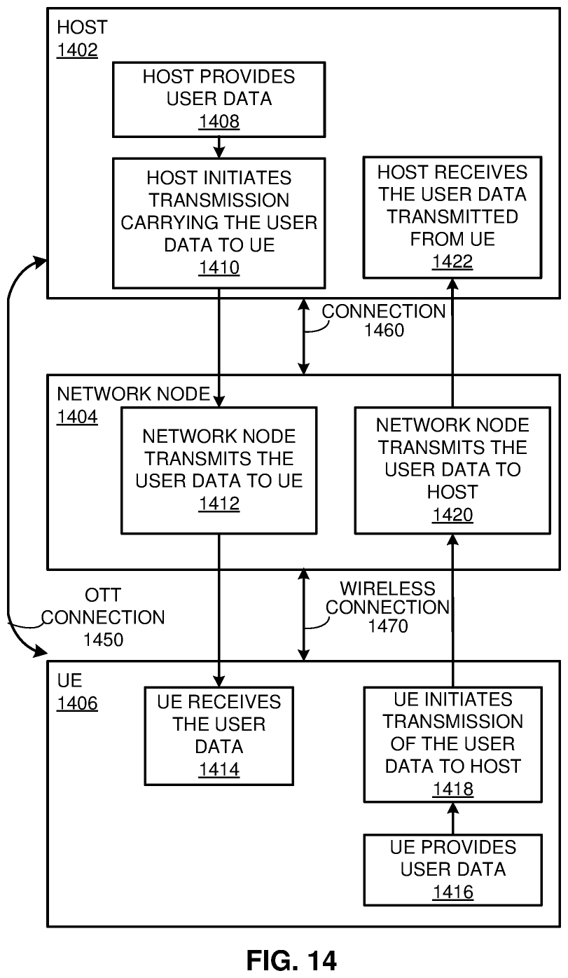

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may add conditions in which an inactivity timer (e.g., drx-HARQ-RTT-TimerDL) and retransmission timer (e.g., drx-RetransmissionTimerDL) can be started, which can guaranteed that the UE will monitor the PDCCH. Consequently, the network can transmit a DL retransmission assignment to recover the data sooner, which can reduce packet delay.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-28. (canceled)

29. A method of operating a communication device of a communications network, the method comprising:
receiving a downlink, DL, hybrid automatic repeat request, HARQ, message for DL semi-persistent scheduling, SPS, from a network node in the communications network;
determining that HARQ feedback has not been transmitted to the network node in response to the DL HARQ message within a period of time; and
responsive to determining that the HARQ feedback has not be transmitted to the network node within the period of time, initiating a timer associated with monitoring for retransmission of the DL HARQ message.

30. The method of claim 29, wherein the DL HARQ message comprises a media access control, MAC, protocol data unit, PDU,
wherein initiating the timer comprises initiating the timer at an end to the period of time or at a first occasion after the period of time ends that the communication device can receive the retransmission of the DL HARQ message, and
wherein monitoring for retransmission of the DL HARQ message comprises monitoring a physical downlink control channel, PDCCH, for downlink control information, DCI, from the network node.

31. The method of claim 29, wherein determining that the HARQ feedback has not be transmitted to the network node within the period of time comprises determining that the response is scheduled during a DL time slot.

32. The method of claim 29, further comprising:
receiving maximum deferral configuration information from the network node, the maximum deferral configuration information indicating a maximum deferral of dropping the DL HARQ message,
wherein determining that the HARQ feedback has not be transmitted to the network node within the period of time comprises determining that the HARQ feedback has not been transmitted within the maximum deferral.

33. The method of claim 29, wherein the timer comprises an inactivity timer indicating an amount of time that the communication device will wait before monitoring for retransmission of the DL HARQ message, optionally, wherein the inactivity timer comprises a drx-HARQ-RTT-TimerDL timer.

34. The method of claim 29, wherein the timer comprises a retransmission timer indicating an amount of time that the communication device will monitor for retransmission of the DL HARQ message, optionally, wherein the retransmission timer comprises a drx-RetransmissionTimerDL timer.

35. The method of claim 29, further comprising:
monitoring for retransmission of the DL HARQ message from the network node based on the timer.

36. The method of claim 29, further comprising:
receiving configuration information from the network node, the configuration information indicating that the communication device is to initiate the timer in response to failing to transmit the HARQ feedback,
wherein initiating the timer comprises initiating the timer based on the configuration information.

37. A method of operating a network node of a communications network, the method comprising:
transmitting a downlink, DL, hybrid automatic repeat request, HARQ, message for semi-persistent scheduling, SPS, to a communications device in the communications network;
determining that HARQ feedback in response to the DL HARQ message has not been received from the communication device within a period of time; and
responsive to determining that the HARQ feedback has not be received from the communication device within the period of time, determining that the communication device has initiated a timer associated with monitoring for retransmission of the DL HARQ message.

38. The method of claim 37, wherein the DL HARQ message comprises a media access control, MAC, protocol data unit, PDU, and
wherein monitoring for retransmission of the DL HARQ message comprises monitoring a physical downlink control channel, PDCCH, for downlink control information, DCI, from the network node.

39. The method of claim 37, wherein determining that HARQ feedback has not be received from the communication device within the period of time comprises determining that the response is scheduled during a DL time slot.

40. The method of claim 37, wherein determining that HARQ feedback has not be received from the communication device within the period of time comprises determining that the response to the DL HARQ message has not been received within a predetermined maximum delay.

41. The method of claim 37, wherein the timer comprises an inactivity timer indicating an amount of time that the communication device will wait before monitoring for retransmission of the DL HARQ message.

42. The method of claim 41, wherein the inactivity timer comprises a drx-HARQ-RTT-TimerDL timer,
the method further comprising:
responsive to the drx-HARQ-RTT-TimerDL timer expiring, retransmitting the DL HARQ message.

43. The method of claim 37, wherein the timer comprises a retransmission timer indicating an amount of time that the communication device will monitor for retransmission of the DL HARQ message.

44. The method of claim 43, wherein the retransmission timer comprises a drx-RetransmissionTimerDL timer,
the method further comprising:
prior to the drx-RetransmissionTimerDL timer expiring, retransmitting the DL HARQ message.

45. The method of claim 37, further comprising:
retransmitting the DL HARQ message to the communication device based on the timer.

46. The method of claim 37, further comprising:
transmitting configuration information to the communication device, the configuration information indicating that the communication device initiate the timer in response to failing to transmit the HARQ feedback and the configuration information including an indication of a maximum deferral of dropping the DL HARQ message.

47. A communication device operating in a communications network, the communication device comprising:
processing circuitry; and
memory coupled to the processing circuitry and having instructions stored therein that are executable by the processing circuitry to cause the communication device to perform operations comprising the operations of claim 29.
